(19) United States
(12) Patent Application Publication
(10) Pub. No.: US 2024/0028722 A1
(43) Pub. Date: Jan. 25, 2024

(54) Methods, Devices, and Systems for Sanitizing a Neural Network to Remove Potential Malicious Data

(71) Applicant: Bank of America Corporation, Charlotte, NC (US)

(72) Inventors: Kenneth Longshaw, Charlotte, NC (US); Matthew Murray, Roanoke, TX (US); Garrett Botkin, Charlotte, NC (US)

(21) Appl. No.: 17/868,123

(22) Filed: Jul. 19, 2022

(51) Int. Cl. G06F 21/56; G06N 3/08

(52) U.S. Cl. CPC G06F 21/566; G06N 3/08; G06F 2221/033

(57) ABSTRACT

Systems, devices, and methods for protecting a user computer devices/network from malicious code embedded in a neural network is described. A security platform may selectively modify a downloaded neural network model and/or architecture to remove neural network parameters that may be used to reconstruct the malicious code at an end user of the neural network model. For example, the security platform may remove specific branches of the neural network and/or set specific parameters of the neural network model to zero, such that the malicious code may not be reconstructed at an end-user device.

### FIELD

Aspects described herein generally relate to the field of machine learning, and more specifically to sanitizing a neural network model for removal of malicious code or data.

### BACKGROUND

Artificial neural networks constitute powerful machine learning algorithms that be employed for a variety of computing tasks that require artificial intelligence. Artificial neural networks, inspired from biological by biological neural networks, comprise interconnected artificial neurons. Each of the neurons may perform a processing function (e.g., apply a transformation/weight to an input signal) and transmit a generated output signal to a next neuron of the network for further processing. Neurons in a neural network are modeled in the form of layers, with neurons a layer receiving input from a previous layer and transmitting the output to a next layer of the network. Applications areas of neural networks are wide ranging and include control systems, pattern recognition, data analysis, medical diagnosis, video games, machine translation, finance, among many others.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure provide effective, efficient, scalable, and convenient technical solutions that address various issues associated with potential malicious code/malware that may embedded into a neural network model. For example, the methods, devices, and systems described herein enable effective sanitization of a downloaded neural network model prior to use at a local computer.

In accordance with one or more arrangements, a system may comprise a user computing device and a security platform. The security platform may comprise at least one processor; and memory storing computer-readable instructions that, when executed by the at least one processor, cause the security platform to perform one or more operations. The security platform may receive, from the user computing device, model parameters of a neural network. The security platform may perform a retraining process for the neural network. The retraining process may comprise: providing an input to a plurality of input nodes of the neural network; generating, from one or more output nodes, an output based on the input; and determining an error value based on the output, an expected output, the input, and a loss function. The retraining process may further comprise, based on the error value, updating one or more model parameters. When a quantity of updated model parameters exceeds a threshold value that is based on a total number of model parameters, the security platform may stop the retraining process. The security platform may send, to the user computing device, the updated model parameters of the neural network.

In some arrangements, the stopping the retraining process may further be based on determining that a change of each of values of the updated model parameters exceeds a threshold percentage.

In some arrangements, the security platform may iteratively perform the retraining process until the quantity of the updated model parameters exceeds the threshold value.

In some arrangements, the updating the one or more model parameters may be based on the error value being greater than a threshold error value. The threshold error value may be based on the expected output.

In some arrangements, the model parameters may comprise biases and weights for the neural network. The loss function may be one of: a mean squared error loss function, a binary cross-entropy loss function; or a categorical cross-entry loss function.

In some arrangements, the system may further comprise a database storing, for the retraining process, a plurality of inputs and corresponding expected outputs.

In some arrangements, the updating the one or more model parameters may be based on a gradient descent algorithm.

In accordance with one or more arrangements, a system may comprise a user computing device and a security platform. The security platform may comprise at least one processor; and memory storing computer-readable instructions that, when executed by the at least one processor, cause the security platform to perform one or more operations. The security platform may receive, from the user computing device, weights of a neural network. The security platform may set a first subset of weights to zero. Then, the security platform may provide an input to a plurality of input nodes of the neural network. The security platform may generate, from one or more output nodes, a first output based on the input. The security platform may determine a first error value based on the first output, an expected output, the input, and a loss function. Following this, the security platform may, iteratively, for one or more non-zero weights: modify a non-zero weight by a perturbation value to generate a second weight, provide the input to the plurality of input nodes of the neural network, generate, from the one or more output nodes, a second output based on the input, determine a second error based on the second output, the expected output, the input, and the loss function, and reset the non-zero weight to an original value of the non-zero weight. Then, the security platform may iteratively update the one or more non-zero weights to generate a second subset of weights. The updating a non-zero weight may comprise (i) when a difference between the first error and a second error for the non-zero weight does not exceed a threshold, setting the non-zero weight to zero, or (ii) when the difference between the first error and the second error exceeds the threshold, retaining an original value of the non-zero weight. Finally, the security platform may send, to the user computing device, the first subset of weights and the second subset of weights.

In some arrangements, the security platform may retrain the neural network after updating the non-zero weights. The retraining the neural network may comprise not modifying weights that were set to zero. The system may further comprise a database storing, for the retraining the neural network, a plurality of inputs and corresponding expected outputs.

In some arrangements, the first subset of weights may comprise a tenth, of a total number of weights, with lowest values among the weights of the neural network. In some arrangements, the first subset of weights comprises weights with values lower than a predefined threshold value.

In some arrangements, a perturbation value for a non-zero weight may be a based on an initial value of the non-zero weight.

In some arrangements, the loss function may be one of: a mean squared error loss function, a binary cross-entropy loss function; or a categorical cross-entry loss function.

In some arrangements, the threshold may be based on based on an average value of differences between second errors and the first error. In some arrangements, the threshold may be selected such that non-zero weights for which differences are within a bottom quartile is set to zero. In some arrangements, the threshold may be a predefined fraction of the first error.

### BRIEF DESCRIPTION OF THE DRAWINGS

The present disclosure is illustrated by way of example and not limited in the accompanying figures in which like reference numerals indicate similar elements and in which:

FIG. 1 shows a simplified example of an artificial neural network on which a machine learning algorithm may be executed, in accordance with one or more example arrangements;

FIG. 2 shows a flow for an example neural network-based attack on a computing system, in accordance with one or more example arrangements;

FIG. 3A shows an illustrative computing environment for sanitizing a neural network model, in accordance with one or more example arrangements;

FIG. 3B shows an example security platform, in accordance with one or more examples described herein;

FIG. 4 shows an example algorithm for sanitizing a neural network, in accordance with one or more example arrangements;

FIG. 5 shows an example algorithm for sanitizing a neural network, in accordance with one or more example arrangements; and

FIG. 6 shows an example algorithm for sanitizing a neural network, in accordance with one or more example arrangements

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

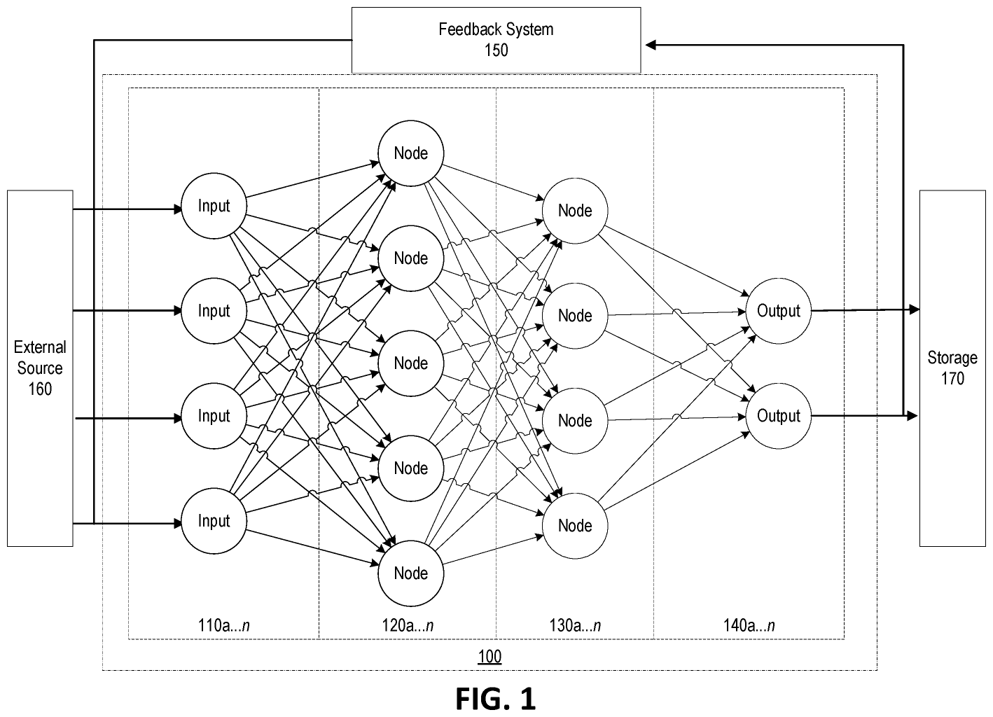

FIG. 1 illustrates a simplified example of an artificial neural network 100 on which a machine learning algorithm may be executed, in accordance with one or more example arrangements. In one example, a framework for a machine learning algorithm may involve a combination of one or more components, sometimes three components: (1) representation, (2) evaluation, and (3) optimization components. Representation components refer to computing units that perform steps to represent knowledge in different ways, including but not limited to as one or more decision trees, sets of rules, instances, graphical models, neural networks, support vector machines, model ensembles, and/or others. Evaluation components refer to computing units that perform steps to represent the way hypotheses (e.g., candidate programs) are evaluated, including but not limited to as accuracy, prediction and recall, squared error, likelihood, posterior probability, cost, margin, entropy k-L divergence, and/or others. Optimization components refer to computing units that perform steps that generate candidate programs in different ways, including but not limited to combinatorial optimization, convex optimization, constrained optimization, and/or others. In some embodiments, other components and/or sub-components of the aforementioned components may be present in the system to further enhance and supplement the aforementioned machine learning functionality.

Machine learning algorithms sometimes rely on unique computing system structures. Machine learning algorithms may leverage neural networks, which are systems that approximate biological neural networks. Such structures, while significantly more complex than conventional computer systems, are beneficial in implementing machine learning. For example, an artificial neural network may be comprised of a large set of nodes which, like neurons, may be dynamically configured to effectuate learning and decision-making.

Machine learning tasks are sometimes broadly categorized as either unsupervised learning or supervised learning. In unsupervised learning, a machine learning algorithm is left to generate any output (e.g., to label as desired) without feedback. The machine learning algorithm may teach itself (e.g., observe past output), but otherwise operates without (or mostly without) feedback from, for example, a human administrator.

Meanwhile, in supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithm may make a guess in a face detection algorithm, ask an administrator to identify the photo in the picture, and compare the guess and the administrator's response. In semi-supervised learning, a machine learning algorithm is provided a set of example labels along with unlabeled data. For example, the machine learning algorithm may be provided a data set of 1000 photos with labeled human faces and 10,000 random, unlabeled photos. In reinforcement learning, a machine learning algorithm is rewarded for correct labels, allowing it to iteratively observe conditions until rewards are consistently earned. For example, for every face correctly identified, the machine learning algorithm may be given a point and/or a score (e.g., “75% correct”).

One theory underlying supervised learning is inductive learning. In inductive learning, a data representation is provided as input samples data (x) and output samples of the function (f(x)). The goal of inductive learning is to learn a good approximation for the function for new data (x), i.e., to estimate the output for new input samples in the future. Inductive learning may be used on functions of various types: (1) classification functions where the function being learned is discrete; (2) regression functions where the function being learned is continuous; and (3) probability estimations where the output of the function is a probability.

In practice, machine learning systems and their underlying components are tuned by data scientists to perform numerous steps to perfect machine learning systems. The process is sometimes iterative and may entail looping through a series of steps: (1) understanding the domain, prior knowledge, and goals; (2) data integration, selection, cleaning, and pre-processing; (3) learning models; (1) interpreting results; and/or (5) consolidating and deploying discovered knowledge. This may further include conferring with domain experts to refine the goals and make the goals more clear, given the nearly infinite number of variables that can possible be optimized in the machine learning system. Meanwhile, one or more of data integration, selection, cleaning, and/or pre-processing steps can sometimes be the most time consuming because the old adage, “garbage in, garbage out,” also reigns true in machine learning systems.

By way of example, in FIG. 1, each of input nodes 110a-n is connected to a first set of processing nodes 120a-n. Each of the first set of processing nodes 120a-n is connected to each of a second set of processing nodes 130a-n. Each of the second set of processing nodes 130a-n is connected to each of output nodes 110a-n. Though only two sets of processing nodes are shown, any number of processing nodes may be implemented. Similarly, though only four input nodes, five processing nodes, and two output nodes per set are shown in FIG. 1, any number of nodes may be implemented per set. Data flows in FIG. 1 are depicted from left to right: data may be input into an input node, may flow through one or more processing nodes, and may be output by an output node. Input into the input nodes 110a-n may originate from an external source 160.

In one illustrative method using feedback system 150, the system may use machine learning to determine an output. The system may use one of a myriad of machine learning models including xg-boosted decision trees, auto-encoders, perceptron, decision trees, support vector machines, regression, and/or a neural network. The neural network may be any of a myriad of type of neural networks including a feed forward network, radial basis network, recurrent neural network, long/short term memory, gated recurrent unit, auto encoder, variational autoencoder, convolutional network, residual network, Kohonen network, and/or other type. In one example, the output data in the machine learning system may be represented as multi-dimensional arrays, an extension of two-dimensional tables (such as matrices) to data with higher dimensionality. Output may be sent to a feedback system 150 and/or to storage 170.

In an arrangement where the neural network 100 is used for determining the data set 320, the input from the input nodes may be raw data and the search string, and the output may be an indication of one or more documents (e.g., in the raw data) that comprise the data set 320. In an arrangement where the neural network 100 is used for determining a solution among a plurality of solutions determined by the NLP engine 225, the input from the input nodes may be the plurality of solutions, and the output may be an indication of a single solution to be implemented by the support platform 110.

The neural network may include an input layer, a number of intermediate layers, and an output layer. Each layer may have its own weights. The input layer may be configured to receive as input one or more feature vectors described herein. The intermediate layers may be convolutional layers, pooling layers, dense (fully connected) layers, and/or other types. The input layer may pass inputs to the intermediate layers. In one example, each intermediate layer may process the output from the previous layer and then pass output to the next intermediate layer. The output layer may be configured to output a classification or a real value. In one example, the layers in the neural network may use an activation function such as a sigmoid function, a Tanh function, a ReLu function, and/or other functions. Moreover, the neural network may include a loss function. A loss function may, in some examples, measure a number of missed positives; alternatively, it may also measure a number of false positives. The loss function may be used to determine error when comparing an output value and a target value. For example, when training the neural network the output of the output layer may be used as a prediction and may be compared with a target value of a training instance to determine an error. The error may be used to update weights in each layer of the neural network.

In one example, the neural network may include a technique for updating the weights in one or more of the layers based on the error. The neural network may use gradient descent to update weights. Alternatively, the neural network may use an optimizer to update weights in each layer. For example, the optimizer may use various techniques, or combination of techniques, to update weights in each layer. When appropriate, the neural network may include a mechanism to prevent overfitting—regularization (such as L1 or L2), dropout, and/or other techniques. The neural network may also increase the amount of training data used to prevent overfitting.

Once data for machine learning has been created, an optimization process may be used to transform the machine learning model. The optimization process may include (1) training the data to predict an outcome, (2) defining a loss function that serves as an accurate measure to evaluate the machine learning model's performance, (3) minimizing the loss function, such as through a gradient descent algorithm or other algorithms, and/or (1) optimizing a sampling method, such as using a stochastic gradient descent (SGD) method where instead of feeding an entire dataset to the machine learning algorithm for the computation of each step, a subset of data is sampled sequentially.

In one example, FIG. 1 depicts nodes that may perform various types of processing, such as discrete computations, computer programs, and/or mathematical functions implemented by a computing device. For example, the input nodes 110a-n may comprise logical inputs of different data sources, such as one or more data servers. The processing nodes 120a-n may comprise parallel processes executing on multiple servers in a data center. And, the output nodes 140a-n may be the logical outputs that ultimately are stored in results data stores, such as the same or different data servers as for the input nodes 110a-n. Notably, the nodes need not be distinct. For example, two nodes in any two sets may perform the exact same processing. The same node may be repeated for the same or different sets.

Each of the nodes may be connected to one or more other nodes. The connections may connect the output of a node to the input of another node. A connection may be correlated with a weighting value. For example, one connection may be weighted as more important or significant than another, thereby influencing the degree of further processing as input traverses across the artificial neural network. Such connections may be modified such that the artificial neural network 100 may learn and/or be dynamically reconfigured. Though nodes are depicted as having connections only to successive nodes in FIG. 1, connections may be formed between any nodes. For example, one processing node may be configured to send output to a previous processing node.

Input received in the input nodes 110a-n may be processed through processing nodes, such as the first set of processing nodes 120a-n and the second set of processing nodes 130a-n. The processing may result in output in output nodes 140a-n. As depicted by the connections from the first set of processing nodes 120a-n and the second set of processing nodes 130a-n, processing may comprise multiple steps or sequences. For example, the first set of processing nodes 120a-n may be a rough data filter, whereas the second set of processing nodes 130a-n may be a more detailed data filter.

The artificial neural network 100 may be configured to effectuate decision-making. As a simplified example for the purposes of explanation, the artificial neural network 100 may be configured to detect faces in photographs. The input nodes 110a-n may be provided with a digital copy of a photograph. The first set of processing nodes 120a-n may be each configured to perform specific steps to remove non-facial content, such as large contiguous sections of the color red. The second set of processing nodes 130a-n may be each configured to look for rough approximations of faces, such as facial shapes and skin tones. Multiple subsequent sets may further refine this processing, each looking for further more specific tasks, with each node performing some form of processing which need not necessarily operate in the furtherance of that task. The artificial neural network 100 may then predict the location on the face. The prediction may be correct or incorrect.

The feedback system 150 may be configured to determine whether or not the artificial neural network 100 made a correct decision. Feedback may comprise an indication of a correct answer and/or an indication of an incorrect answer and/or a degree of correctness (e.g., a percentage). For example, in the facial recognition example provided above, the feedback system 150 may be configured to determine if the face was correctly identified and, if so, what percentage of the face was correctly identified. The feedback system 150 may already know a correct answer, such that the feedback system may train the artificial neural network 100 by indicating whether it made a correct decision. The feedback system 150 may comprise human input, such as an administrator telling the artificial neural network 100 whether it made a correct decision. The feedback system may provide feedback (e.g., an indication of whether the previous output was correct or incorrect) to the artificial neural network 100 via input nodes 110a-n or may transmit such information to one or more nodes. The feedback system 150 may additionally or alternatively be coupled to the storage 170 such that output is stored. The feedback system may not have correct answers at all, but instead base feedback on further processing: for example, the feedback system may comprise a system programmed to identify faces, such that the feedback allows the artificial neural network 100 to compare its results to that of a manually programmed system.

The artificial neural network 100 may be dynamically modified to learn and provide better input. Based on, for example, previous input and output and feedback from the feedback system 150, the artificial neural network 100 may modify itself. For example, processing in nodes may change and/or connections may be weighted differently. Following on the example provided previously, the facial prediction may have been incorrect because the photos provided to the algorithm were tinted in a manner which made all faces look red. As such, the node which excluded sections of photos containing large contiguous sections of the color red could be considered unreliable, and the connections to that node may be weighted significantly less. Additionally or alternatively, the node may be reconfigured to process photos differently. The modifications may be predictions and/or guesses by the artificial neural network 100, such that the artificial neural network 100 may vary its nodes and connections to test hypotheses.

The artificial neural network 100 need not have a set number of processing nodes or number of sets of processing nodes, but may increase or decrease its complexity. For example, the artificial neural network 100 may determine that one or more processing nodes are unnecessary or should be repurposed, and either discard or reconfigure the processing nodes on that basis. As another example, the artificial neural network 100 may determine that further processing of all or part of the input is required and add additional processing nodes and/or sets of processing nodes on that basis.

The feedback provided by the feedback system 150 may be mere reinforcement (e.g., providing an indication that output is correct or incorrect, awarding the machine learning algorithm a number of points, or the like) or may be specific (e.g., providing the correct output). For example, the machine learning algorithm 100 may be asked to detect faces in photographs. Based on an output, the feedback system 150 may indicate a score (e.g., 75% accuracy, an indication that the guess was accurate, or the like) or a specific response (e.g., specifically identifying where the face was located).

In an exemplary neural network, an output from an output node may be expressed as a function of an input at the plurality of input nodes. For example, if the outputs from the first set of processing nodes 120a-n are represented as bₐ, b_{b} . . . bₙ and inputs from the input nodes 110a-n is represented as aₐ, a_{b} . . . aₙ, a value of an output node bₙ may be represented as:

bₙ=A(aₐwₐ+aₐw_{b}+ . . . aₙwₙ−x) Equation (1)

where A is the activation function, wₐ, w_{b} . . . wₙ are the weights applied to at the input nodes 110a-n, and x is a bias value applied to the function. Each output bₐ, b_{b} . . . bₙ from the first set of processing nodes may be similarly processed at the second set of processing nodes, each of which may be associated with its own set of biases and weights. Processing, in this manner at each of layers of intermediary nodes, outputs may be generated at the output nodes 140a-n. Training a neural network, as described above, comprises setting optimal values of weights and biases to achieve a required level of accuracy for a given function of the neural network. Weights and biases of the neural network may be referred to model parameters of the neural network.

A malicious actor may set parameters of a neural network in manner such that the parameter values can be recombined to generate a malicious code (e.g., malware, computer virus, etc.). In an exemplary scenario, a computing system may be compromised to include a software for generating a malicious code from neural network parameters. When a user downloads a neural network model (e.g., neural network parameters from an online database), the software may process the model parameters to generate a malware code. The malware code may then be executed to infect the computing system.

The above mechanism of attack may circumvent any malware protection suites that may be employed at the computing system. Further, many developers often use readily available and trained neural networks for their applications. This may make it feasible for a malicious actor to train a neural network that may employed without modification by an end user. As such, and because the neural network may still be functional for its intended purpose (e.g., image recognition), an end-user may remain in the dark regarding the true nature of the neural network.

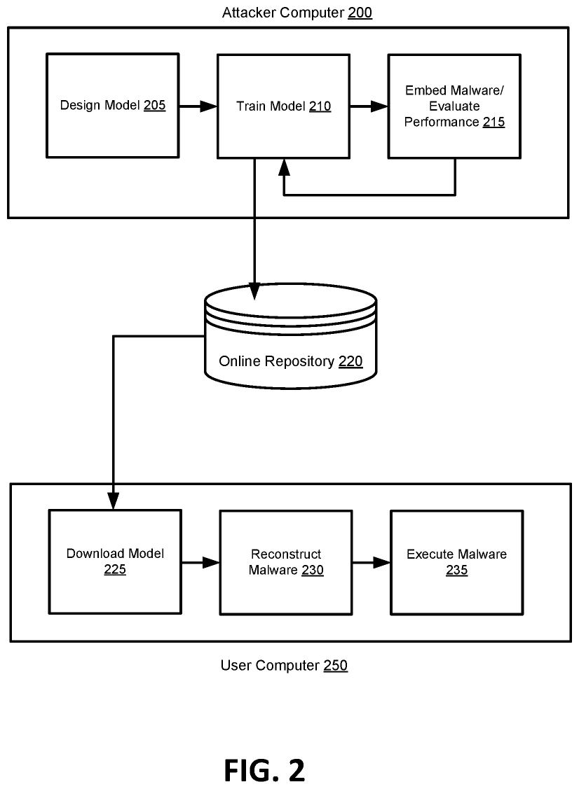

FIG. 2 shows an illustrative flow for an example neural network-based attack on a computing system. At step, 205, a malicious actor, using an attacker computer 200, may design a suitable neural network model for a given application. For example, the malicious actor may designate a type of neural network, a number of layers for the neural network, and a number of nodes to be used for each layer of the neural network. At step 210, the attacker may train the neural network model to achieve a required level of accuracy (e.g., as described above with reference to FIG. 1).

At step 215, the attacker may embed, within the trained neural network model, malware code. For example, the attacker may replace a subset of parameters (e.g., weights and biases) of the trained neural network model with values/data that may correspond to a malicious code. In an example scenario, the neural network model may comprise parameters that are represented using n-bit floating point numbers (e.g., 4-bit floating point numbers). Thus, each model parameter may potential store n/8 bytes of data. The attacker may break the malware code into multiple blocks of data, with each block comprising n/8 bytes of the malware code. With some neural network models comprising millions, or even billions of parameters, an attacker may successfully store multiple megabytes of malware code within a neural network model without substantively affectively accuracy of the neural network with respect to its “clean version.” At step 215, the attacker may evaluate the accuracy of the neural network model to ensure it fits the desired criteria of performance.

If needed, the attacker may iteratively retrain the neural network model to increase its accuracy, Retraining may comprise fixing the values of the parameters that store the blocks of the malicious code. The attacker may evaluate the accuracy until a desired level of accuracy is achieved. The trained model, along with the embedded malicious code, may then be published to an online repository generally used for sharing AI/ML models to other users in the field.

At step 225, an unsuspecting user may download the infected neural network model (e.g., model parameters) to their user computer 250. At step 230, and with the aid of a local software installed on the user computer 250, the malicious code may be reconstructed using the subset of parameters that comprise the blocks of the malicious code. At step 235, the malicious code may be executed on the user computer 250 potentially compromising it or any private network that it may be connected to.

Various example methods, devices, and/or systems described herein may enable modifying/sanitizing a neural network model such that any parameters that may be used to generate a malicious code at the user computer 250 may be destroyed. In some arrangements, selected parameters may be set to zero, or certain nodes/pathways of the neural network may be removed, without affecting the operation/performance of the neural network. Additionally, or alternatively, techniques described herein may enable retraining of a downloaded neural network model in a manner that reconstructing the malicious code may not be possible at the user computer 230.

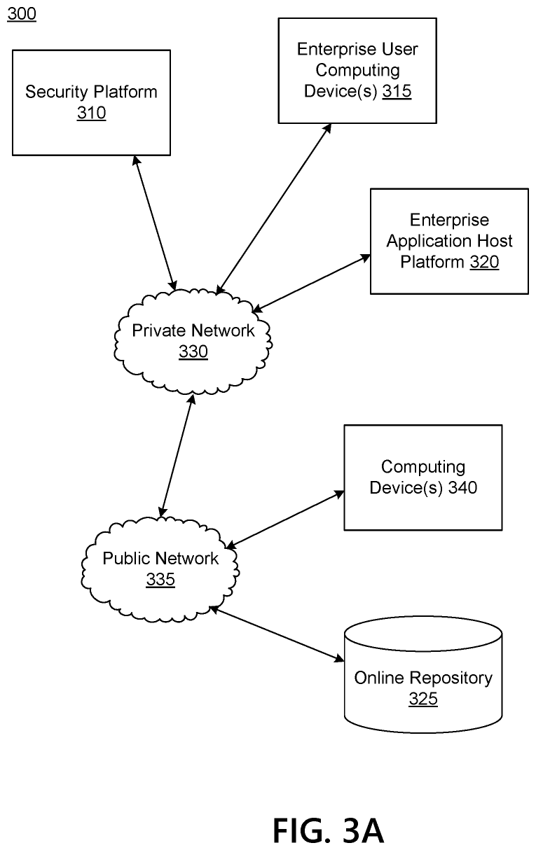

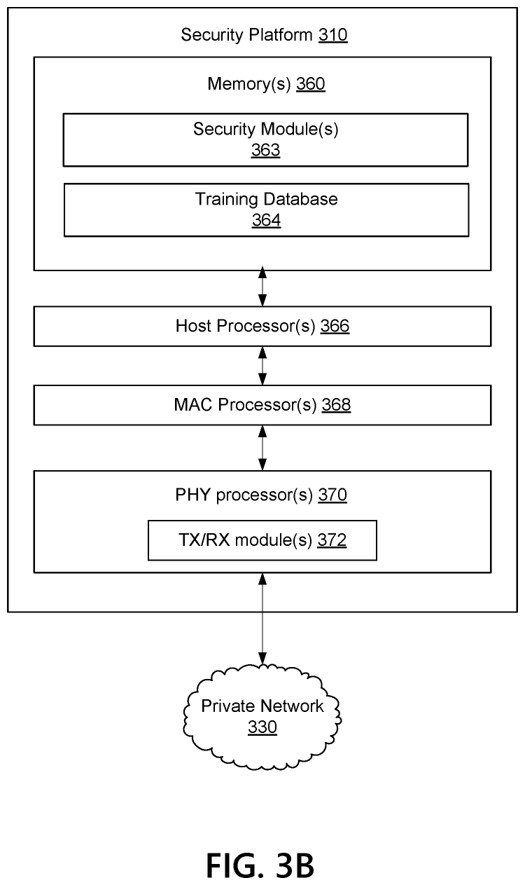

FIG. 3A shows an illustrative computing environment 300 for sanitizing a neural network model, in accordance with one or more arrangements. The computing environment 300 may comprise one or more devices (e.g., computer systems, communication devices, and the like). The one or more devices may be connected via one or more networks (e.g., a private network 330 and/or a public network 335). For example, the private network 330 may be associated with an enterprise organization which may develop and support service, applications, and/or systems for its end-users. The computing environment 300 may comprise, for example, a security platform 310, an online repository 325, one or more enterprise user computing device(s) 315, and/or an enterprise application host platform 320 connected via the private network 330. Additionally, the computing environment 300 may comprise one or more computing device(s) 340 and an online repository 325 connected, via the public network 335, to the private network 330. Devices in the private network 330 and/or authorized devices in the public network 335 may access services, applications, and/or systems provided by the enterprise application host platform 320 and supported/serviced/maintained by the security platform 310.

The devices in the computing environment 300 may transmit/exchange/share information via hardware and/or software interfaces using one or more communication protocols over the private network 330 and/or the public network 335. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3r d Generation Partnership Project (3GPP) cellular protocol, a hypertext transfer protocol (HTTP), and the like).

The security platform 310 may comprise one or more computing devices and/or other computer components (e.g., processors, memories, communication interfaces) configured to perform one or more functions as described herein. Further details associated with the architecture of the security platform 310 are described with reference to FIG. 3B.

The enterprise application host platform 320 may comprise one or more computing devices and/or other computer components (e.g., processors, memories, communication interfaces). In addition, the enterprise application host platform 320 may be configured to host, execute, and/or otherwise provide one or more services/applications for the end-users. For example, if the computing environment 300 is associated with a financial institution, the enterprise application host platform 320 may be configured to host, execute, and/or otherwise provide one or more transaction processing programs (e.g., online banking application, fund transfer applications, electronic trading applications), applications for generation of regulatory reports, and/or other programs associated with the financial institution. As another example, if the computing environment 300 is associated with an online streaming service, the enterprise application host platform 320 may be configured to host, execute, and/or otherwise provide one or more programs for storing and providing streaming content to end-user devices. The above are merely exemplary use-cases for the computing environment 300, and one of skill in the art may easily envision other scenarios where the computing environment 300 may be utilized to provide and support end-user applications.

The enterprise user computing device(s) 315 may be personal computing devices (e.g., desktop computers, laptop computers) or mobile computing devices (e.g., smartphones, tablets). In addition, the enterprise user computing device(s) 315 may be linked to and/or operated by specific enterprise users (who may, for example, be employees or other affiliates of the enterprise organization). An authorized user (e.g., an employee) may use an enterprise user computing device 315 to develop, test and/or support services/applications provided by the enterprise organization. The enterprise user computing device(s) 315 may download neural network models from the online repository 325 for local usage and/or usage within the private network 330. Further, the enterprise user computing device(s) 315 may have and/or access tools/applications to operate and/or train neural network models for various services/applications provided by the enterprise organization.

The computing device(s) 340 may be personal computing devices (e.g., desktop computers, laptop computers) or mobile computing devices (e.g., smartphones, tablets). An authorized user (e.g., an end-user) may use a computing device 340 to access services/applications provided by the enterprise organization, or to submit service requests and/or incident reports associated with any of the services/applications.

The online repository 325 may comprise neural network models as stored at a network accessible database. The neural network models may comprise algorithms, architecture, model parameters (e.g., weights and biases), etc., as may have been submitted/uploaded by various users connected to the private network 330 and/or the public network 335. Other users (e.g., associated with computing device(s) 340 and/or the enterprise user computing device(s) 315) may download the neural network models for use on a computing device. The online repository may be associated with one or more of volatile and nonvolatile, removable and non-removable media implemented in any method or technology for storage of information such as computer readable instructions, data structures, program modules and/or other data. Computer-readable storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium.

In one or more arrangements, the security platform 310, the online repository 325, the enterprise user computing device(s) 315, the enterprise application host platform 320, the computing device(s) 340, and/or the other devices/systems in the computing environment 300 may be any type of computing device capable of receiving input via a user interface, and communicating the received input to one or more other computing devices in the computing environment 300. For example, the security platform 310, the online repository 325, the enterprise user computing device(s) 315, the enterprise application host platform 320, the computing device(s) 340, and/or the other devices/systems in the computing environment 300 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the security platform 310, the online repository 325, the enterprise user computing device(s) 315, the enterprise application host platform 320, the computing device(s) 340, and/or the other devices/systems in the computing environment 300 may, in some instances, be and/or comprise special-purpose computing devices configured to perform specific functions.

FIG. 3B shows an example security platform 310, in accordance with one or more examples described herein. The security platform 310 may comprise one or more of host processor(s) 366, medium access control (MAC) processor(s) 368, physical layer (PHY) processor(s) 370, transmit/receive (TX/RX) module(s) 372, memory 360, and/or the like. One or more data buses may interconnect host processor(s) 366, MAC processor(s) 368, PHY processor(s) 370, and/or Tx/Rx module(s) 372, and/or memory 360. The security platform 310 may be implemented using one or more integrated circuits (ICs), software, or a combination thereof, configured to operate as discussed below. The host processor(s) 366, the MAC processor(s) 368, and the PHY processor(s) 370 may be implemented, at least partially, on a single IC or multiple ICs. Memory 360 may be any memory such as a random-access memory (RAM), a read-only memory (ROM), a flash memory, or any other electronically readable memory, or the like.

Messages transmitted from and received at devices in the computing environment 300 may be encoded in one or more MAC data units and/or PHY data units. The MAC processor(s) 368 and/or the PHY processor(s) 370 of the security platform 310 may be configured to generate data units, and process received data units, that conform to any suitable wired and/or wireless communication protocol. For example, the MAC processor(s) 368 may be configured to implement MAC layer functions, and the PHY processor(s) 370 may be configured to implement PHY layer functions corresponding to the communication protocol. The MAC processor(s) 368 may, for example, generate MAC data units (e.g., MAC protocol data units (MPDUs)), and forward the MAC data units to the PHY processor(s) 370. The PHY processor(s) 370 may, for example, generate PHY data units (e.g., PHY protocol data units (PPDUs)) based on the MAC data units. The generated PHY data units may be transmitted via the TX/RX module(s) 372 over the private network 330. Similarly, the PHY processor(s) 370 may receive PHY data units from the TX/RX module(s) 372, extract MAC data units encapsulated within the PHY data units, and forward the extracted MAC data units to the MAC processor(s). The MAC processor(s) 368 may then process the MAC data units as forwarded by the PHY processor(s) 370.

One or more processors (e.g., the host processor(s) 366, the MAC processor(s) 368, the PHY processor(s) 370, and/or the like) of the security platform 310 may be configured to execute machine readable instructions stored in memory 360. The memory 360 may comprise one or more program modules/engines having instructions that when executed by the one or more processors cause the security platform 310 to perform one or more functions described herein. The one or more program modules/engines and/or databases may be stored by and/or maintained in different memory units of the security platform 310 and/or by different computing devices that may form and/or otherwise make up the security platform 310. For example, the memory 360 may have, store, and/or security module(s) 363 and/or a training database 364.

The security module(s) 363 may have instructions/algorithms that may cause the security platform 310 to implement machine learning processes in accordance with the examples described herein. For example, the security module(s) 163 may comprise instructions for (re)training a downloaded neural network model and/or modifying an architecture/parameters of a downloaded neural network model in accordance with the various examples described herein. The training database 364 may comprise various test input and output data that may be used for (re)training a downloaded neural network model.

While FIG. 3A illustrates the security platform 310, the enterprise user computing device(s) 315, the enterprise application host platform 320, as being separate elements connected in the network 135, in one or more other arrangements, functions of one or more of the above may be integrated in a single device/network of devices. For example, elements in the security platform 310 (e.g., host processor(s) 366, memory(s) 360, MAC processor(s) 368, PHY processor(s) 370, TX/RX module(s) 372, and/or one or more program/modules stored in memory(s) 160) may share hardware and software elements with and corresponding to, for example, the enterprise application host platform 320 and/or the enterprise user devices 315.

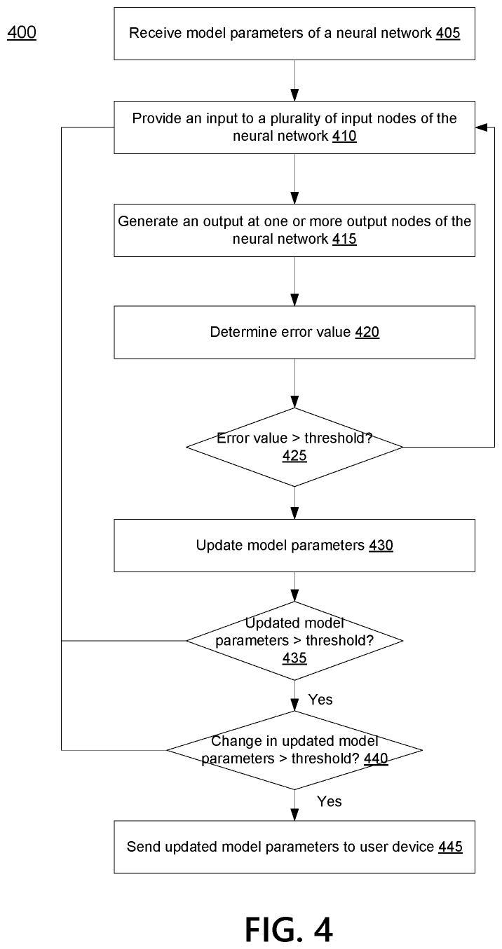

FIG. 4 shows an example algorithm 400 for sanitizing a neural network. In an arrangement, the security platform 310 may perform the various steps as shown in FIG. 4. At step 405, the security platform 310 may receive (e.g., from the user computing device 315) values of model parameters of the neural network. The model parameters may comprise, for example, values of weights and biases of the neural network. The security platform may further receive an architecture (e.g., number of input nodes, output nodes, intermediary nodes, interconnections between the nodes, etc.) of the neural network.

At step 410, the security platform 410 may provide an input to a plurality of input nodes of the neural network. At step 415, and based on the input, the neural network may generate an output at one or more output nodes of the neural network. At step 420, the security platform 310 may determine an error value for the input. The error value may be determined based on the input, the generated output, an expected output for the input, and a loss function. The training database 364 may store multiple input values and corresponding expected output values that may be used at the security platform 310. Applying the input to the neural network may comprise the security platform 310 selecting the input value from the multiple input values stored in the training database.

Various types of loss functions may be used based on a function of the neural network. For example, a binary cross-entropy function may used if the neural network is for a binary classification purpose (e.g., if the neural network is for determine one of two possible outcomes for a given input). A categorical cross-entropy function may be used if the neural network is for a multiclass classification purpose (e.g., if the neural network is for determine one of multiple possible outcomes for a given input). A mean squared error loss function may be used to if the neural network is for generating a single output value for a given input. Any other type of loss function may be used. The error value may be used to update the model parameters (e.g., weights) of the neural network.

At step 425, the security platform 310 may determine whether the error value is greater than a threshold error value. If the error value if less than the threshold error value, the security platform 310 may select a next input to provide to the input nodes and not update the model parameters. This enables the neural network to only be updated if an error is large, thus ensuring that the neural network accuracy is improved for inputs that may otherwise lead to large errors. Ignoring small errors may also ensure that this retraining procedure is substantially sped up. The threshold error value may be determined based on the expected output. The threshold error value may be defined as a percentage of the expected output.

At step 430, and if the error value is greater than (or equal to) the threshold, the security platform 310 may update the model parameters (e.g., weights) of the neural network. The security platform 310 may use, for example, a gradient descent algorithm to update the weights of the neural network.

At step 435, the security platform 310 may determine whether a number of updated model parameters is greater than a threshold quantity. If the number of updated model parameters is less than the threshold quantity, the security platform 310 may select a next input to provide to the input nodes (e.g., return to step 410). This enables the security platform 310 to continue the process until the model parameters are substantially modified from the original model parameters as received. Substantially modifying the model parameters ensures that any redundancy of malicious code that may have been built into the model parameters is erased. If the number of updated model parameters is greater than (or equal to) a threshold quantity, the security platform 310 may proceed to step 440.

At step 440, the security platform 410 may determine whether the changes in values of the updated model parameters each exceed a threshold value. If the changes in one or more values of the updated model parameters are less than the threshold quantity, the security platform 310 may select a next input to provide to the input nodes (e.g., return to step 410). Similar to above, this enables the security platform 310 to continue the process until the model parameters are substantially modified from the original model parameters as received. If the changes in values of the updated model parameters each exceed (or are equal to) a threshold value, the security platform 310 may proceed to step 445. At step 445, the security platform 445 may send the updated model parameter to the user computing device 315.

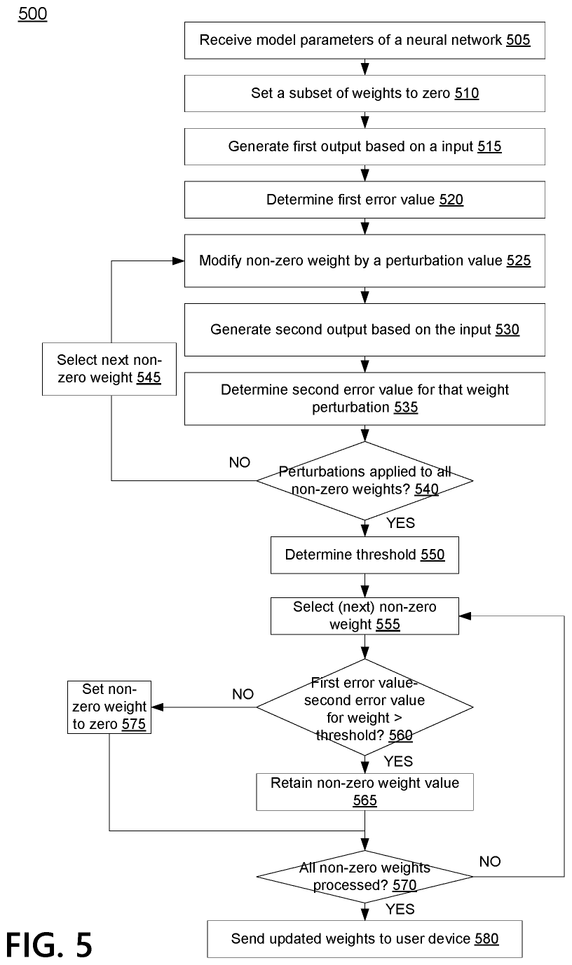

FIG. 5 shows an example algorithm 500 for sanitizing a neural network. In an arrangement, the security platform 310 may perform the various steps as shown in FIG. 5. At step 505, the security platform 310 may receive (e.g., from the user computing device 315) values of model parameters of the neural network. The model parameters may comprise, for example, values of weights and biases of the neural network. The security platform may further receive an architecture (e.g., number of input nodes, output nodes, intermediary nodes, interconnections between the nodes, etc.) of the neural network.

At step 510, the security platform 310 may set a subset of weights to zero. For example, the security platform may set weights that are already set to very small values (e.g., 0.1, 0.001, etc.) to zero. The security platform 310 may set weights that are less than a threshold value to zero.

At step 515, the security platform 410 may provide an input to a plurality of input nodes of the neural network to generate an output at one or more output nodes of the neural network. At step 520, the security platform 310 may determine a first error value for the input. The error value may be determined based on the input, the generated output, an expected output for the input, and a loss function. The training database 364 may store multiple input values and corresponding expected output values that may be used at the security platform 310. Applying the input to the neural network may comprise the security platform 310 selecting the input value from the multiple input values stored in the training database. any of the loss functions described with respect to FIG. 4 may be used for this purpose.

At step 525, the security platform 310 may modify a non-zero weight by a perturbation value. The perturbation value may be a fixed fraction of the non-zero weight. The security platform 310 may add or subtract the perturbation value to the non-zero weight to obtain a perturbed weight.

At step 530, the security platform 310 may provide the input to the plurality of input nodes of the neural network to generate an output at the one or more output nodes of the neural network. At step 535, the security platform 310 may determine a second error value for the input. The second error value may be determined based on the input, the generated output at step 530, the expected output for the input, and the loss function.

At step 540, the security platform 310 may check whether perturbations have been applied to all non-zero weights. At step 545, if perturbations have not been applied to all non-zero weights, the security platform 310 may select a next non-zero weight and repeat the steps 525, 530, and 535. Any perturbation applied in the previous iteration of steps 525, 530, and 535 is reversed (the original value of the previously perturbed weight is retained). In this manner, a plurality of second error values is obtained, with each of the second error values corresponding to a perturbation of a non-zero weight.

At step 550, the security platform 310 may determine a threshold. The threshold may be based on an average value (or median value) of differences between the first error value and the second error values corresponding to perturbations of the non-zero weights. The threshold may be, for example, a fraction of the average value (or median value). Alternatively, the threshold may be set that a fixed percentile of non-zero weights have differences between the first error value and the second error value that is greater than and/or equal to the threshold. Alternatively, the threshold may be based on the first error value (e.g., a fraction of the first error value).

At step 555, the security platform 310 may select a non-zero weight. At step 560, the security platform 310 may determine whether a difference between the first error value and a second error value obtained for the non-zero weight (after perturbation, at step 535) is greater than (or equal to) the threshold. At step 565, and if the difference is greater than the threshold, the security platform 310 may retain the value of the non-zero weight (e.g., not change the value of the value of the non-zero weight). At step 575, and if the difference is less than the threshold, the security platform 310 may set the non-zero weight to zero.

At step 570, the security platform 310 may determine whether all non-zero weights have been processed via steps 560 and 565 (or step 575). If all non-zero weights have not been processed, at step 555, a next non-zero weight is selected and steps 560 and 565 (or step 575) is performed for the next non-zero weight. In this manner, each of the non-zero weight is processed to either set the non-zero weight to zero or retain the original value of the non-zero weight.

At step 580, the security platform 310 may send the updated weights to the user computing device 315. In an arrangement, the neural network may be retrained (e.g., with multiple input values and corresponding expected output values as stored in the training database 364) prior to sending the updated weights to the user computing device 315. Retraining the neural network may comprise not changing the values of weights that have been set to zero at steps 510 or 575. Retraining the neural network may enable the neural network retain the desired level of functionality despite the modifications applied to the weights via the algorithm of FIG. 5.

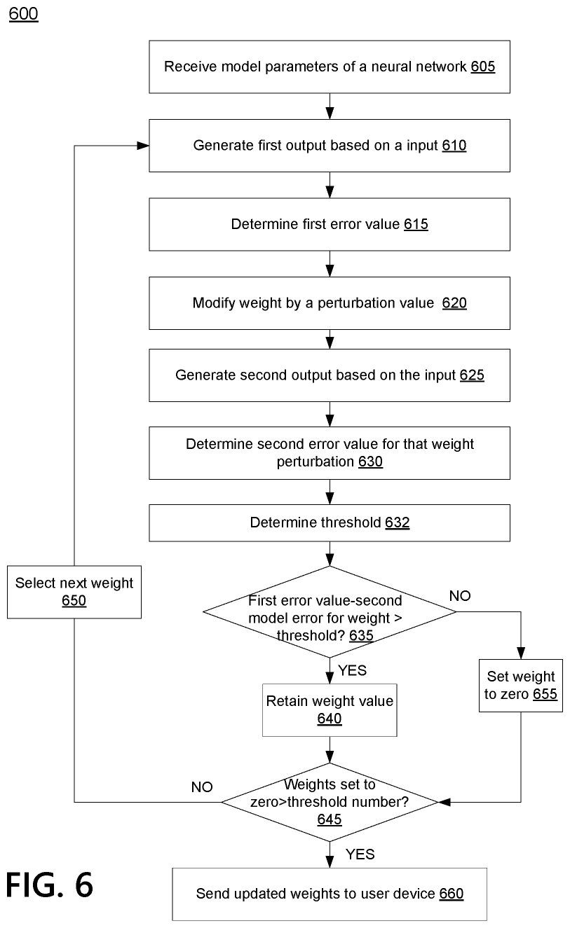

FIG. 6 shows an example algorithm 600 for sanitizing a neural network. In an arrangement, the security platform 310 may perform the various steps as shown in FIG. 6. At step 605, the security platform 310 may receive (e.g., from the user computing device 315) values of model parameters of the neural network. The model parameters may comprise, for example, values of weights and biases of the neural network. The security platform may further receive an architecture (e.g., number of input nodes, output nodes, intermediary nodes, interconnections between the nodes, etc.) of the neural network.

At step 610, the security platform 410 may provide an input to a plurality of input nodes of the neural network to generate an output at one or more output nodes of the neural network. At step 615, the security platform 310 may determine a first error value for the input. The error value may be determined based on the input, the generated output, an expected output for the input, and a loss function. The training database 364 may store multiple input values and corresponding expected output values that may be used at the security platform 310. Applying the input to the neural network may comprise the security platform 310 selecting the input value from the multiple input values stored in the training database. any of the loss functions described with respect to FIG. 4 may be used for this purpose.

At step 620, the security platform 310 may modify a weight by a perturbation value. The perturbation value may be a fixed fraction of the weight. The security platform 310 may add or subtract the perturbation value to the weight to obtain a perturbed weight.

At step 625, the security platform 310 may provide the input to the plurality of input nodes of the neural network to generate an output at the one or more output nodes of the neural network. At step 630, the security platform 310 may determine a second error value for the input. The second error value may be determined based on the input, the generated output at step 625, the expected output for the input, and the loss function.

At step 632, the security platform 310 may determine a threshold. The threshold value may be based on the first error value (e.g., a fraction of the first error value). At step 635, the security platform 310 may determine whether a difference between the first error value and the second error value (obtained at step 630) is greater than (or equal to) the threshold. At step 640, and if the difference is greater than the threshold, the security platform 310 may retain the value of the weight (e.g., not change the value of the value of the weight). At step 655, and if the difference is less than the threshold, the security platform 310 may set the weight to zero.

At step 645, the security platform 310 may determine whether a number of weights that have been set to zero is greater than a threshold quantity. The threshold quantity may be equal to a fraction (e.g., 10%, 25%, 40%, 50%, etc.) of the total number of weights in the neural network.

If the number of weights set to zero is less than the threshold quantity, the security platform 310 may select a next weight at step 650 and perform the steps 610, 615, 620, 625, 630, 632, 635, 640 (or step 655) for that weight. This enables the security platform 310 to iteratively process the weights until a sufficient number of weights are set to zero. This effectively substantially modifies the neural network, thereby ensuring that any redundancy of malicious code that may have been built into the weights is erased. If the number of weights that is set to zero is greater than (or equal to) the threshold quantity, the security platform 310 may proceed to step 660.

At step 660, the security platform 310 may send the updated weights to the user computing device 315. Ending the process of setting the weights to zero based on the check performed at step 645 allows the processing of the neural network at the security platform 310 to be sped up. For example, the security platform 310 need not process every single one of the weights using the steps 610-640 prior to sending the weights to the user computing device 315.

In an arrangement, the neural network may be retrained (e.g., with multiple input values and corresponding expected output values as stored in the training database 364) prior to sending the updated weights to the user computing device 315. Retraining the neural network may comprise not changing the values of weights that have been set to zero at step 655. Retraining the neural network may enable the neural network retain the desired level of functionality despite the modifications applied to the weights via the algorithm of FIG. 6.

The various methods, devices, and systems described herein may enable a security platform to modify a neural network in a manner that any malicious code inserted into the model parameters is sufficiently corrupted. Modification of the neural network parameters ensures that the malicious code may not be reconstructed using the model parameters at the user computing device 315. Further, various steps described herein may enable the model parameters to be sufficiently modified thereby overcoming any redundancy that may have been built into the neural network for carrying the malicious code.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a user computing device; and
a security platform comprising
a processor; and
memory storing computer-readable instructions that, when executed by the processor, cause the security platform to:
receive, from the user computing device, model parameters of a neural network;
perform a retraining process for the neural network, wherein the retraining process comprises:
providing an input to a plurality of input nodes of the neural network;
generating, from one or more output nodes, an output based on the input;
determining an error value based on the output, an expected output, the input, and a loss function; and
based on the error value, updating one or more model parameters;
when a quantity of updated model parameters exceeds a threshold value that is based on a total number of model parameters, stopping the retraining process; and
send, to the user computing device, the updated model parameters of the neural network.

2. The system of claim 1, wherein the stopping the retraining process is further based on determining that a change of each of values of the updated model parameters exceeds a threshold percentage.

3. The system of claim 1, wherein the computer-readable instructions, when executed by the processor, cause the security platform to iteratively perform the retraining process until the quantity of the updated model parameters exceeds the threshold value.

4. The system of claim 1, wherein the updating the one or more model parameters is based on the error value being greater than a threshold error value, wherein the threshold error value is based on the expected output.

5. The system of claim 1, wherein the model parameters comprise biases and weights for the neural network.

6. The system of claim 1, wherein the loss function is one of:
a mean squared error loss function,
a binary cross-entropy loss function; or
a categorical cross-entry loss function.

7. The system of claim 1, further comprising a database storing, for the retraining process, a plurality of inputs and corresponding expected outputs.

8. The system of claim 1, wherein the updating the one or more model parameters is based on a gradient descent algorithm.

9. A method comprising
receiving, from a user computing device, model parameters of a neural network;
performing a retraining process for the neural network, wherein the retraining process comprises:
providing an input to a plurality of input nodes of the neural network;
generating, from one or more output nodes, an output based on the input;
determining an error value based on the output, an expected output, the input, and a loss function; and
based on the error value, updating one or more model parameters;
when a quantity of updated model parameters exceeds a threshold value that is based on a total number of model parameters, stopping the retraining process; and
send, to the user computing device, the updated model parameters of the neural network.

10. The method of claim 9, wherein the stopping the retraining process is further based on determining that a change of each of values of the updated model parameters exceeds a threshold percentage.

11. The method of claim 9, further comprising iteratively performing the retraining process until the quantity of the updated model parameters exceeds the threshold value.

12. The method of claim 9, wherein the updating the one or more model parameters is based on the error value being greater than a threshold error value, wherein the threshold error value is based on the expected output.

13. The method of claim 9, wherein the model parameters comprise biases and weights for the neural network.

14. The method of claim 9, wherein the loss function is one of:
a mean squared error loss function,
a binary cross-entropy loss function; or
a categorical cross-entry loss function.

15. The method of claim 9, further comprising a database storing, for the retraining process, a plurality of inputs and corresponding expected outputs.

16. The method of claim 9, wherein the updating the one or more model parameters is based on a gradient descent algorithm.

17. A non-transitory computer readable medium storing computer executable instructions that, when executed by a processor, causes a security platform to:
receive, from a user computing device, model parameters of a neural network;
perform a retraining process for the neural network, wherein the retraining process comprises:
providing an input to a plurality of input nodes of the neural network;
generating, from one or more output nodes, an output based on the input;
determining an error value based on the output, an expected output, the input, and a loss function; and
based on the error value, updating one or more model parameters;
when a quantity of updated model parameters exceeds a threshold value that is based on a total number of model parameters, stopping the retraining process; and
send, to the user computing device, the updated model parameters of the neural network.

18. The non-transitory computer readable medium of claim 17, wherein the stopping the retraining process is further based on determining that a change of each of values of the updated model parameters exceeds a threshold percentage.

19. The non-transitory computer readable medium of claim 17, wherein the computer executable instructions, when executed by the processor, cause the security platform to iteratively perform the retraining process until the quantity of the updated model parameters exceeds the threshold value.

20. The non-transitory computer readable medium of claim 17, wherein the updating the one or more model parameters is based on the error value being greater than a threshold error value, wherein the threshold error value is based on the expected output.
